(19) United States
(12) Patent Application Publication
(10) Pub. No.: US 2020/0175590 A1
(43) Pub. Date: Jun. 4, 2020

(54) Method to turn digital rental buyer into subscriber and an apparatus to secure access & trade the rental item

(71) Applicant: Shu Ya Huo, San Francisco, CA (US)

(72) Inventor: Shu Ya Huo, San Francisco, CA (US)

(21) Appl. No.: 16/350,532

(22) Filed: Nov. 29, 2018

(51) Int. Cl. G06Q 40/04; G06F 21/10; H04L 9/08

(52) U.S. Cl. CPC G06Q 40/04; G06F 21/105; H04L 2209/56; G06F 2221/0768; H04L 9/0816

(57) ABSTRACT

The field of this invention relates to a network users electronic digital data item transaction process and a method to transform the transaction process into a in-subscription based trading process. More particularly, it relates to a computer implemented method that turn digital data items transacted on network into a subscription network where the former standalone digital data item buyer-renter who can only consume the rental items, will be transformed to a subscriber-buyer-renter and will be able to sell the digital data items bought as rental to target markets at appealing prices and earn revenue together with stakeholders, including at least the digital data item owner, the marketplace owner and technology vendor, beside just consume of it. While the sold digital rental data item could be purchased by subscribers within or outside of the subscription network worldwide for increased business revenue. It also involve the use of router and end user-buyers IP address to determine the target market region for routing the digital data items' secure deliver by a digital right management (DRM) system, and a multi-level digital data item trading distribution and revenue distribution method controlled by IDs of the rented digital data collections' stake holds and their respective device IP addresses', etc.

### FIELD OF THE INVENTION

The field of this invention relates to a network users electronic digital title data item transaction process and a method to transform the transaction process into a in-subscription based trading process. More particularly, it relates to a computer implemented method that turn digital title data items transacted on network into a trading application subscriber where the former standalone digital data item buyer-renter who can only consume the rental items, will be transformed to a subscriber buyer and renter, and will be able to sell the digital data items he/she bought as rental to target markets consumers at appealing prices and earn revenue together with stakeholders, including at least the digital title data item owner, the marketplace owner and technology vendor, beside just consume of it. While the sold digital rental data item could be purchased by subscribers within or outside of the subscription network worldwide for increased business revenue. It also involve the use of router and end user-buyers IP address to determine the target market region for routing the digital data items' secure deliver by a digital right management (DRM) system, and an up to 3 tiered digital title data item secure trading, delivery, access, and revenue distribution method controlled by IDs of the rented digital data collections' stakeholders, and their respective device IP addresses' and its equipped eUICC chip, etc.

### BACKGROUND OF THE INVENTION

U.S. Pat. No. 7,607,158 and U.S. patent application Ser. No. 12/591,884 (patent allowed by attorney notification) describes two idle electronic information data item selection for trade methods used for traditional TV network programming and for online video title items generated Dealpack Trading, where both for subscribed items in a subscription network setting from 1^{st} network subscribers to a 2n^{d} network subscribers. These systems are all set up to focus on idle digital data items on subscription network selection for doing Dealpack Trading (Dealpack is the digital title data item collection package from i=0 to i=n items). There is not yet a system that focus on direct buy and sell (retail) online digital title data items transactions that are also doing Dealpack Trading among subscribers of the same network and also for outside standalone individual non-subscriber consumers, who when want to purchase the item, will be prompt to join in the subscription.

Currently, electronic digital information data items (such as TV program apps, e.g. apps from channels like ABC, CBS, FOX, NBC, Turner, TNT, Amazon Channels, etc.), SVOD [subscription video on demand titles, e.g. Netflix, Hulu, Amazon Prime Video, CBS All Access, HBO Now, ShowTime, etc.], and TVOD [transaction video on demand titles, e.g. Apple iTune and App Store, Google Play Store, and Amazon, etc.] and their respective apps; books titles, music titles, and their respective apps, such as Sportify, Apple/Google Musics, etc.), are all provided by digital title data owners to online digital title data item marketplace operators, who aggregate and assemble the digital title data items by lists (such as channels, titles, apps), availability (such as time of release or shelf life) and categories/genre, to sell or rent to buyers at a price at once or on a monthly subscription basis. For TVOD, traditionally, titles are listed on a marketplace individually and sell by title's owner and the online marketplace web/app operator directly to consumers, who browse those titles and select those likes to buy for a price at once or rent for a price for a period of time, say for example, in 30 days with 48 hours viewing times.

### SUMMARY OF THE INVENTION

The objective of this invention is to provide a solution that will enable the digital title data item content owners to sell those items directly via rentals at once and sell them via a new way by those renters, the customers, who have rented those items, via Dealpack Trading, to sublet those rentals to generate additional revenue for the items' (include its content data and related metadata generated along the content production process from origination by owner to the customer (FIG. 1), including marketplace operator and rental buyer and seller and/or rent-to-own buyers (or buyer turned buyer-subscriber, the buyer-sub). In order to realize the objective of the invention, this invention provides a computer implemented method to do the Dealpack Trading through an trading app offered through the marketplace under a subscription plan. The Dealpack are priced in accordance to the marketplace business rules by seller subscribers (seller-sub) for target markets' geographical regions.

In one preferred embodiment of the invention, the computer implemented method includes a network online marketplace trading (web) app installed on devices with front-end user interface (UI), and connected with server/back-end of cable/satellite head-ends, computer network nodes at the edge, or gateway-hub/container-cloud-clusters, for text, graphics, sound/voice, touch/click data input/output and data processing, storing and caching at front, and data controlled routing/relay/distribution/delivery, to and from container based cloud clusters connected via Wan and/or Lan (wire routed and wireless networked with access point of Wi-fi gateway/hub and/or cellular connection), and peer to peer networks that are connected at the edge with terminal client devices, such as mobile phone, tablet, PC/notebook, STB[set-top-box], SMP[streaming media player], TV set (connected TV or analog/digital TV set), game counsel, and browsers or native UI of those devices, etc. Through the app/device/browser UI, subscribers can go to an online Marketplace/Store (M/S) to rent digital title data items by a process of selecting the items (such as video/music/book titles) to rent, pay the rentals, consume the rented item in the defined rental period, and send the rental Dealpack (idle for-not-use, for-trade item) to Trading M/S for listing to do sublet trade within the remaining time limit of the allowed watching period, and/or the remaining period's multiplication by business term made by the stakeholders for the traded Dealpack. The Dealpack shall then be indexed, tagged, classified and curated via ways of manual and/or automatic (such as artificial intelligence (AI) and machine learning (ML) algorithms by items' metadata and resulting trained attributes, and listed on the M/S by genre, category and/or mode of feeling for fast, easy, accurate search, discovery, recommendation, social and traded by the individual renters turned subscribers. Those for trade Dealpack content is still stored in the marketplace database server centralized location and/or CDNs' clouds (for those with usage level >M times), or decentralized storage in case of peer to peer operation, encoded and/or encrypted ready for distribution upon sublet rental transaction indication signal/message.

Due to digital title data item piracy concern, the generation of the Dealpack item, especially, premium hit item that are valuable worth with high price tag, must be protected for its content, consumption data and transaction metadata. Depending on the degree of value of the content data, the protection method can also be varied from high to low, which means from hardware-root or trust embedded Hollywood approved DRM method, to regular software based encryption and decryption access authentication and authorization methodology. The Dealpack is protected via such DRM mechanism, either via integrating a 3^{rd} party commercial multi-DRM service in the cloud, or through M/S′ owned partial or full access control DRM system. Either way, the DRM system shall incorporate the Dealpack ID, which at least associated with the digital content item ID, the title's owner ID, the M/S′ ID, the seller subscriber ID and the buyer subscriber/customer ID, the end user device mac address, IMSI-HLR/HSS [int'l mobile subscriber identity-home location register/home subscriber server], IP address, and 3^{rd} party DRM vendor ID if the vendor is hired. The access control shall incorporate a process that include verification of the user subscriber/customer by his/her device identity through checking the private key stored on the device and its matching device mac address, IP address with subscriber/customer ID (IMSI-HLR/HSS, if mobile device), and with the data item's public key stored on a control machine at different location, and verification of payment by checking with the payment status by the subscriber/customer account ID, where either the user ID and the payment status is not matching or the payment is at fault, the access then is denied, or, be authorized. Evidently, public key associated with matching private key, is encrypted with the data items including the content title item and the metadata item at the time of transaction happened.

Subscriber or customer data, including personal consumption data and transaction data, are vital to a business' success, respect and protect those data make a good successful business from a poor or failing business. Current ads revenue based online social and content business use customers' personal data and consumption data for ads targeting freely. Subscription based online content business also use those data for free with the suspect of privacy invasion. Dealpack Trading by subscribers and content owners with marketplace operators allow subscribers to earn revenue, and their trading data is mutually aware of for joint earning effort, and those Dealpack trading based usage data are permitted by Dealpack Trading subscribers/customers by default for their benefit. For subscriber private consumption data, they are configured by using a masked identity and/or blockchain mechanism that will immune to subscription marketplace/network host operator and the employed trading app. For example, the content viewing data, such as title, ID, director/actor/actress name, year, category/genre, etc. Metadata that allow the host or other interest party to identify the title, shall use a hashing method to hide-out from viewing, still other statistical analytic data, such as time played, how long, ads viewed time and length, item payment, etc., are view-able to them, and is offered as a setup option given to user/subscriber to hash/hide items in the host back end if he select to do so.

The above mentioned Dealpack generating process includes multiple ways to do it by subscribers via the user interface (UI). One of most appealing option is to use natural voice conversation language to do it, such as:
Sub: “I like this movie (ABC), please save to my favorite” (you just watched “ABC”)
Host: “OK, do you like others to save for later watch, or do you want to Dealpack it for trade?”
Sub: “I'd like to do the trade, what else in my favorite that I watched?
Host: “there are 3 more watched, and 2 un-watched”
Sub: “send the 3 together with this just watched, Dealpack them and send to trade”
Host: “What about the market you want to sell, do you have any preference, or you
want us to handle it for you?”
Sub: “I'll let you do it for me.”
Host: “We'll do it. Have nice day.”

The back-end of the system will do the packaging by calculating the remaining or selected range of time variable determined interval value allowed, and other operation and/or business variables for Dealpack Trading (variable such as pricing, markets, revenue splits, rental terms, etc.) for each Dealpack title item and set prices, and send related trading business data and metadata to the trading M/S for listing. While at the trading M/S, the Dealpack items, after receiving, sorting, classifying, inserting to the right listing location, is listed under the seller-sub ID and/or Dealpack ID, the title brand name, under a category/genre/mode for each item, indexed and tagged by metadata and attributes of it, with a price for rent at a term, or for rent-to-own under another business term, targeting to the business targeted market regions (if several regions involved, each region could be priced differently accordingly).

The buyer-sub and customers who bought the Dealpack Trading app shall login and browse the listing Dealpack items and select to buy the chosen one(s). Once payment cleared, the Dealpack shall be DRM encrypted through hardware or software based, symmetric [such as: FEAL (Fast Encryption Algorithm), IDEA (International Data Encryption Algorithm), DES (Data Encryption Standard), AES (Advanced Encryption Standard), or RC5(Rivest Cipher, by Ronald Rivest)] and/or asymmetric [such as: RSA (Rivest, Shamir and Adleman) or ECC (Elliptic Curve Cryptography)], hashing (such as CRC, MD5, or Sha-256) methodologies, depending on the degree of the content value for the purchase, and the access control mechanism shall start to authenticate the buyer subscriber/customer for authorization (in the case the marketplace and subscriber are separate business entities): if the subscriber ID is authorized, then the content shall be encrypted together with the asymmetric public key of the buyer-sub, a symmetric key, subscriber ID, Dealpack ID, timestamp of purchasing, sublet rental term, and content data are encrypted with the asymmetric key with Dealpack ID [for previously delivered and more used Dealpack, therefore, stored at the edge CDN (content distribution network)/cache already, then need to link the Dealpack listing data with the same Dealpack ID to do the encryption] and transmitted via IP network (ground or satellite) to the edge CDN storage or local closest cache, through which, to deliver to the final end user subscriber/customer player on his/her terminal device or browser, via secure transport protocols (such as SSL/TLS, SSH, etc.), where the build in decryption algorithm/mechanism, such as the private key matching method, shall be used to verify the public key that come with the same Dealpack ID, and triggered to get the license ticket from a license server to decrypt the content, and if the buyer-sub's private-public key pair matched in the case of a native player such as Apple devices, or via in browser/player decryption mechanism of EME/CDM (Encryption Media Extension/Content Decryption Module) in case such as Google Chrome/devices, the content shall be decrypted and played for viewing. Future streaming format of current two major camps, the Apple HLS (HTML Live Streaming) and the rest of Mpeg-Dash (Moving Picture Expert group-Dynamic Adaptive Streaming over HTML) may be merged to one, the Common Media Application Format (CMAF), and the current encryption methods of CENC (common encryption) and AES-CTR/CBC (Advanced Encryption Standard-Counter/Cipher Block Chaining) merging to AES-CBCS (according to VeriMatrixx), where codec is evolving from H.264-H.265NP9 to AV1/VVC (Alliance-for-Open-Media Video 1/Versatile Video Coding). All will make Dealpack processing easier, faster and cheaper.
Using a hypothetical use case as example: ABC Marketplace/Store (M/S) offer rental and purchase on its free Movie+TV (web) App (MTA) for TVOD titles with S/D/R/S[Search/Discovery/Recommendation/Social] features. If add T (Trading Dealpack) feature, will make the MTA sell-able for a price, say at $1.99/mo for subscription membership, that will immediately allow the M/S, digital content data owner and subscriber to earn revenue. The M/S has a term of 30 days limit, have 2 day to finish watch once started. After the subscribe-renter rented a movie, watched it, the remaining time of 48 hours can be Dealpack traded at lower prices for target markets. Say:

a movie rented @$4.99 can Dealpack it to trade @$0.29-1.49

| | |
|---|---|
| or | @$2.99 can Dealpack it to trade @$0.29-0.99 |
| or | @$0.99 can Dealpack it to trade @$0.29-0.39 |

The $0.29-0.39 are the price level most Asia, ME, Africa and the rest of the world beside developed world can afford. It should draw more buyers for price below $0.99/title at the restricted region. Many services are differentiated and restricted to a region by gateway router number and/or IP addresses, the same for Dealpack. All Dealpack revenue earned will be distributed by term among stakeholders, that include at least M/S who licensed the Dealpack and incorporated the T(Trading Dealpack) into its MTA app to do S/D/R/S/T. For subscriber who bought the app with T ability, if did rent 3 hit movies in a month & sold Dealpacks, most possible earning would be more than what the subscriber paid for the app:

| - if 4x people buy those movies, 4x3=12 @$0.39=$4.6 | |
|---|---|
| if 8x | $10 |

$5 revenue is >2× of subscriber paid, $10 is >5× subscriber paid for subscribing the MTA
result: motivates all digital title rental buyers to buy the subscription MTA
The same token with Apple and Amazon, Google, Tencent, Alibaba, JD, etc, who have media app stores. Actually, Apple is number 1 in term of TVOD title rental and sales, second place is Amazon for the time being.

By the above exemplary case business term, if only 24 hours viewing time within 15 days, the viewed item(s) shall be destroyed after viewing if it is downloaded due to bandwidth restriction, controlled by the DRM management rule/policy/rental-term, or if in the case of ample bandwidth, no download is needed, while just controlled for the secure access by the DRM according to the rental term. If for a rent-to-own item, the term may be 12 months, renewable each month for a rental fee, and own it after 12 months: the item shall permanently owned by the buying subscriber/customer, and be given a secure access key after the last renewal, unless stopped pay the the last renewal.

The world is diverse in economic development levels. For the same product or service, the price is various in great deal in different regions. Even in the US, the price level also different by the 50 states up to 50% from high price consumption states to lower level ones. In term of media entertainment programming TV and video, the difference between the US and European countries and Japan, Hong Kong, Taiwan, Singapore, Australia is averaged 30-40%, meaning the US price for subscription pay TV or video is 30-40% more than Europe, etc., while comparing with Asia and Latin America and Eastern Europe, the average price difference is around 60-80%. For example, EPL sold worldwide right to Sky TV boss Mr. Murdoch, who if used its European pay TV operators' subscriber to do the Dealpack in unprotected countries and sell Dealpack to Asian countries like China without paying a licensing fee, could earn 70% less revenue than if EPL does it through the US′. While through the US' pay TV/video subscribers to do Dealpack with patent licensing, could sell to China for “one stone kill 2 birds”: keep earning current existing subscribers' revenue and earning extra 2× Dealpack Trading revenue from both US and European subscribers and still sell the Dealpack to China, keep existing subscriber loyal to host operator and earn 2 level revenue: Tier1, US Dealpack sales to Europe, Tier2, Europe to China. Same thing for Europe/Japan/Hong Kong & Taiwan operations: Tier1, EP/JP/HK-TW, etc. Dealpack sales to the US, Tier2, US to China/Asia/Africa/ME, etc.

This leads to another embodiment of this invention, do Dealpack trading through a 2/3-Tier trading scheme centered with the top ARPU pay TV/video services enjoyed by the US service providers. Example:
Eurpean (EP)-SVOD(ES) 4 hit movies sell to US MVPDs*/SVODs/vMVPDs** operators' (UO) Doing 4 movie Dealpack (Dlpk) Trading by the EP-SVOD subscribers via its app/web:

| US-Trade | SVOD price | Subs Rev | Dlpk Price | Sell/BuySub | Dlpk Rev |
|---|---|---|---|---|---|
| Tier1 ES −> UO | $8/mo | $80m/mo | $6/mo | 5m/40m | $240m/mo |
| Tier2UO −> Rest | | | $3 | 20m/100m | $300m/mo |
| Total $620m<= | | $80 | | | $540m/mo |

* MVPD—Multi-Video-Program-Distributor.
** vMVPD—virtual MVPD, the online TV channel

US-SVOD w/10 m subscribers (US) 4 movies to EP MVPDs/SVODs/vMVPDs operators (EO)
   Doing 4 hit movie Dealpack Trading by the US-SVOD subscribers(subs) via its app/web:

| EP-Trade | SVOD price | Subs Rev | Dlpk Price | Sell/BuySub | Dlpk Rev |
|---|---|---|---|---|---|
| Tier1 US −> EO | $10/mo | $120m/mo | $4/mo | 5m/40m | $160m/mo |
| Tier2 EO −> Rest | | | $2 | 20m/100m | $200m/mo |
| Total $460m<= | | $120m/mo | | | $360m/mo |

Internet online distribution for video programming via fixed line and mobile broadband is definitely gaining huge momentum, with near 80% TV subscribers also doing one or more OTT[over-the-top] online SVODs via apps or websites. More than 200 TV channels are on Amazon Channels, in Apple App Store and in Google Play Store, etc., in the form of content apps. Those app stores as marketplaces, take for granted, charge 15%-30% from users signing up with those apps' subscription services and in-app transactions. This causing apps owners (complaining charging “tax” to apps) and store owners are conflicting to block each others, and trending a loss for both sides. This give Dealpack another strong good reason to cut-in for a deal to allow M/S owners doing something good, not just collecting high “tax”, but give app owner a way to earn more, e.g. the M/S will OK apps that don't do the subscription split when they choose to block/away for new user signup, but offer a way to help the subscription content apps to earn more, so as to qualify M/S owner to earn with them together to split the revenue using Dealpack Trading added earning features to its own bundle/package app, just like legacy linear TV channel bundle, but to bundle OTT digital content apps, such as SVODs+TVODs, and vMVPDs into M/S's own content bundle/package(B/P) apps for a OTT package price, for a hypothetical example:
For an about $20/mo B/P may include any combination of Netflix ($10), Curiosity ($6), Allaccess ($10), Hulu ($8), HBOnow ($15), Showtime ($12), FilmStruck ($11); Univision (Spanish)($8)
Another B/P may be DisneyLife($15) & Nicklodadine($6) & Crounchyroll ($10) for ˜$10
Another for vMVPD B/P may include any combination of:
   Hulu Live ($40), Youtube TV ($40), ESPN+($5), DirecTVnow ($40), FuboTV ($45), SlingTV ($20) for ˜$40-$60
etc.,
   Then offer Dealpack Trading on top of the B/P to earn both the B/P subscriber fee and Dealpack Trading splits for stakeholders. Certainly, those SVOD/vMVPD apps are still available in the M/S “A La Carte” and together with the aggregated/curates B/P content apps to sell. The B/P apps will surely win more subscribers than their standalone counterparts. Just like the bundled TV channels are better than the standalone A La Carte channels. Those more the 200 US TV channels OTT apps (standalone or TV everywhere apps with TV subscriber authentication for access), could be all in those app marketplaces/stores. CBS CEO Mr. Mooves said that CBS channel earns average of $2 via legacy TV, while via streaming app CBS All Access, they earn $6, make 3× more. Tivo said, 64% US TV subscribers watch one or more SVODs. That drive all the TV channels offer standalone apps for a price or TVE apps to access online. Yet, no body will pay the standalone price for a bunch of them, that would cost up to $100-$200 bundle/package price, which make M/S much easier to cut deals (possible do the reverse of 2×-3× cost reduction) with the content app owners to do M/S′ bundle/package app to take the huge device or user base advantage of existing successful M/S, such as Apple App Store and Google Play Store, and an unified UI offering with the ability to do Search+Discover+Recommendation+Social+Trade (Trading Dealpack).

If the digital title data owner decide to go direct to do the sale by lowering price to from say $8-$14 to $2-$5 level to the lower priced market regions, he/she can do that definitely, but it will generate huge churn to existing subscribers in the Tier I market, since people will quit the subscription and go to buy lower priced one in that market. The catch is by doing Dealpack Trade for Tier I subscribers. This will keep grow the existing subscribers without or with little churn, and still able to gain buyers in the rest of the world.

Here is another example to show how the Dealpack Trading process applied to Netflix multi-tier app distribution: the standard Netflix app (sNtflxAp) is used as a whole Dealpack tradable and have some user settings setup for the trade (such as language, target country/region, term, etc), that's it. The app will do the work automatically each time the sub reset the setting configuration.
In the Hispanic market, all the subscribers of Spanish speaking (in US or overseas) will be able to configure the trade by selecting the Spanish language and term (1 or 3 months by the rules for example), and OK for trade, that's it. The Netflix Dealpack will be able to automatically software scripted to do the rest, such as blocking all other language content and the content that has no right to do the trade in the target region/countries, and trading term. This Dealpack Trading Netflix app (dlpk-NtflxAp-Spanish) will be listed on the trading portal for the targeted regions/countries to trade at price for MNOs[mobile network operators]/MVPDs/vMVPDs/ISPs [internet service providers] etc., that is competitive in that market.
iFlix is a content app that is targeted to the south east Asia, in 2 years, developed into 5 million subscriber base, priced at the $2.99 to fit the market demand and purchasing power there, now enters new MENA area.
By doing the dlpk-NetflixAp-Spanish (could be sold as buyer's private label) in LAM [Latin America] area, will be priced at 50% -80% lower than the sNtflxAp (sNtflxAp still sold as it is), but the key benefit is that operator's existing Spanish speaking subs who sell the dlpk-NtflxAp-Spanish become more loyal without cannibalization due to Dealpack earning/saving, yet, still win more new subs in the target area. With more local content will make it even better.
Netflix(N) Dealpack sale to Amerimovil (A) or
   to other MNOs/MVPDs/ISPs in LAM doing dlpk-NtflxAp-Spanish Trading:

| | | | | | |
|---|---|---|---|---|---|
| US-LAM Trade | sNtflx | SubRve | DlpkPrice | SellrSub/BuyrSub | DlpkRev |
| Tier1 N −> A | $10 | $80m/mo | $2.99/mo | 8m/40m | $144m/yr |
| Tier2 ... | | | | | |

US-TW-HK-Macao Trade ...

```
  -RU-Trade ...
  -PH-Trade ...
  -IND-Trade
.....
```

Without Dealpack Trading, directly selling at $3 sNtflxAp, will cause cannibalization and loss of revenue.
The same situation could be used for Japan. Using US Japanese speaker as a leverage for tier1 subs and operator, Sprint-Softbank for example, subs as Tier 2 subs. There are 1.3 m Japanese 1st and 2nd language speakers in the US, 7.7 m titles of Japanese content on Netflix, together with English content subtitled/dubbed in Japanese, it is best positioned to do the Netflix-Dlpk-JP.
There are 7.6 m Netflix titles for the US, 6.6 m titles for Netflix Canada, 6.1 m for Netflix UK and 5.7 m title for Netflix Brazil. They are all good for Ntflx-Dlpk-xLuangauge trade.

The key principles of this invention can all be used for the embodiment of the Dealpack Trading for the online education class lessens of schools, from k-12, to college/universities. Especially useful in the case for rare high value classes, where enrollment/admission rate is high, such as those top ranked the universities in the US and the world, where we usually see 5-10 out of 50,000-100,000 admission rate, controlled by extreme high academic standard and high cost of study, like in the US case, the average cost of study in college and university are about $30,000/year, and the top ranked ones are costing between $50,000-$100,000/year. Class-Dealpack Trading will fully utilize these high valued education resource to make it affordable and available to the world mass. Release the burden of the average about $30,000 school loan incurred from college/university study by the about 70% of students in the US when shortly after or even before their graduation, not lasting 10-20 years to pay back, but while in their are study. Good examples are the online class teaching/lecturing recording and saved study materials (text book, homework, test/exam and communication between students and teachers) that are OK'd by the teacher/school and traded by students in the form of school LMS [Learning Management System] administered, subject classified Class-Dealpacks, and purchased by organized study groups at local level and jointly administered by a degree-award oriented and quality controlled program by the master school and the study group. Widely used tools are Google Classroom type, that also available from Apple and Microsoft, etc. Together with the top ranked schools, could take the advantage of the Class-Dealpack brings.

The Dealpack is also best implemented by blockchain technology through tokenizing it, and used for Dealpack Trading payment with conditioned exchange for cash and equity. The distributed secure transaction ledger system and smart contract of the blockchain can be used with token to secure authenticate the Dealpack digital title and record the transaction on conditioned usage life-cycle, and its revenue distribution for the stakeholders in accordance with the transaction log. The distributed storage system, especially the peer to peer storage cost saving feature could also greatly reduce the overall cost of Dealpack distribution. The smart contract is functioning pretty much the same as a DRM to verify payment, issue license ticket, record transaction and instruct the Dealpack ID linked title physical data stored at CDNs/caches/P2P with same Dealpack ID to deliver, decrypt and play the title.

The objective and characteristics of the invention will become apparent from the following drawings and the detailed description.

### BRIEF DESCRIPTION OF THE DRAWINGS

FIG. 2 is the block diagram on a timeline of Dealpack generation and Trading in the overall media production and distribution workflow.

FIG. 1 is the flow chart of the individual renter buyer and seller traditional online trade and the transformation process turning a regular renter-buyer into Dealpack Trading subscriber

FIG. 3 is the process block diagram of the Dealpack search, selection, buy and sell data flow by a subscriber using the Dealpack Trading app.

FIG. 3′ is the digital title play-run timeline timestamp control points by Dealpack trading Tier I-III.

FIG. 4 is the flow chart of Dealpack Trading process; FIG. 4′ is the diagram to show the selection variable ranges/thresholds.

FIG. 5 is the block diagram of Dealpack encryption and decryption control delivery for play by a Control Access(CA)/DRM system with eUICC and Blockchain system connected.

FIG. 6 is the flow chart of purchased Dealpack encryption and decryption process.

FIG. 6′ is the regular value Dealpack key flow process chart.

FIG. 7 is Dealpack sublet App/Widget/List diagram displayed on the M/S.

FIG. 8 is the diagram of transforming a free retail buyer into a Dealpack Trading app subscriber.

FIG. 9-11 is the wholesale group trading exemplary case's web front display and order process visual illustration.

### DETAILED DESCRIPTION

FIG. 1 described one embodiment of an overall implementation of this invention in the media entertainment industry, including the overall position in the content creation and distribution chain life-cycle along a timeline of 115, from content titles' owner 104, to distributor 107, to end consumers 113, divided by three workflow tracks: Dealpack 101, film 102, TV 103. The TV and film tracks start from content creation planing, production and post-production 105, further goes into new release window 108 for cinemas/movie-theaters (usually about 6 months, yet, trending to a simultaneous release of both theaters and secure OTT distribution with Dealpack right authorize) and DVD distribution, including corresponding online purchase via secure download (TVOD). The next enters the TV channel providers including both TV channel and corresponding OTT online channels 109, which further enter the TV/video aggregators (including cable, satellite, telecom TV operators) for broadcasting via syndicated networks and local stations, and online VOD and live streaming operators 111. The OTT online distribution are typically through a subscription of a website or device native video player application, either offered by standalone channel owners 109 or aggregators 111. All finally reaches the consumer subscribers 114 of their corresponding services. The Dealpack track 101 is corresponding in parallel to the TV103/film102 track' respective activities. Start with content owners' post-production, including owner right authorization 106 to do the work of content translation, dubbing, subtitles caption, and to establish the Dealpack trading right, authorized by the content owner (content owner register/contract with or license permit at the marketplace), agreed by its operators (including aggregators, broadcasters, traditional TV or OTT streaming, live or VOD, and marketplaces), including owner operator 108, 109, 111 and subscribers 114 through doing Dealpack trade at the marketplace 110. Finally the subscriber 114 select digital title items to do Dealpack trading 112.

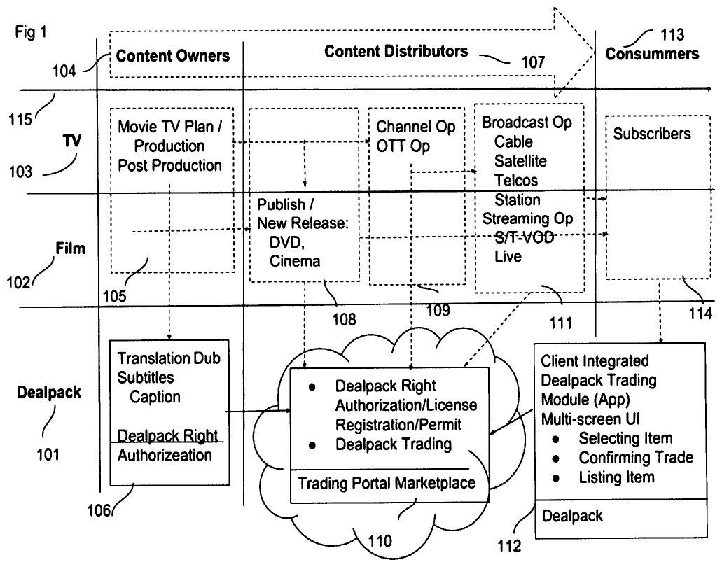

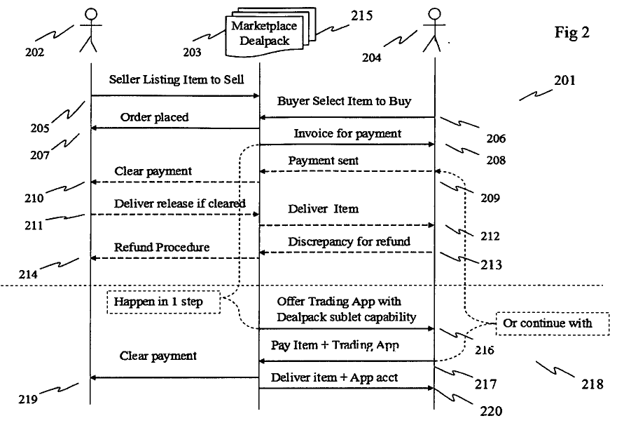

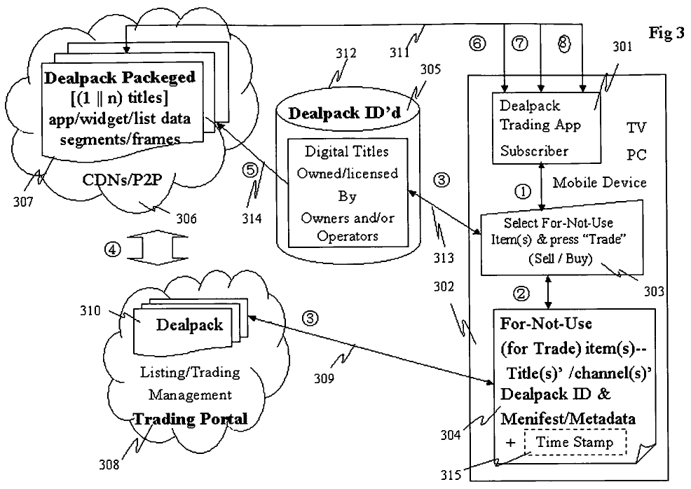

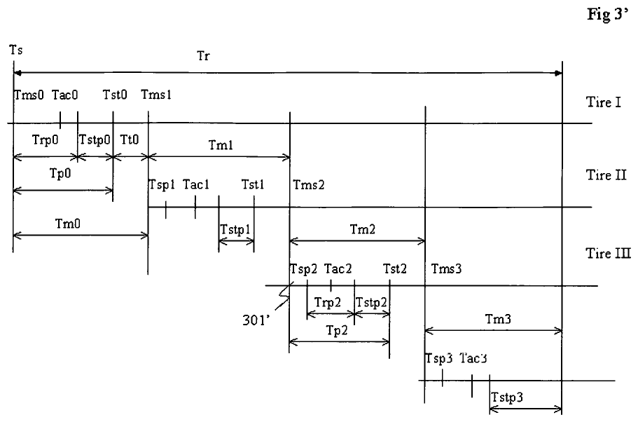

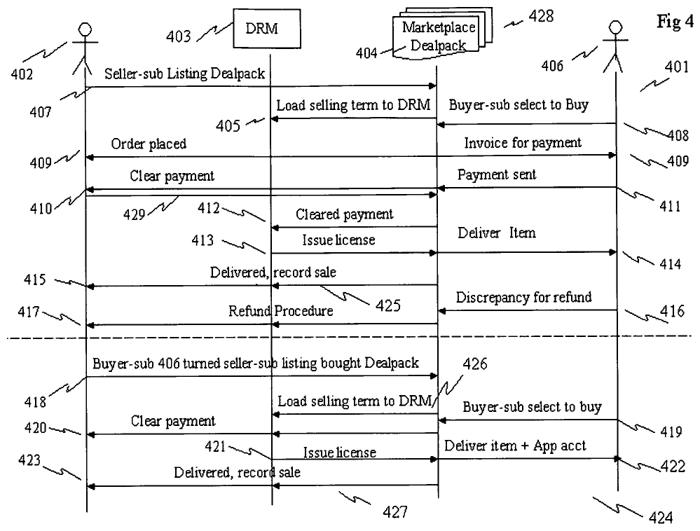

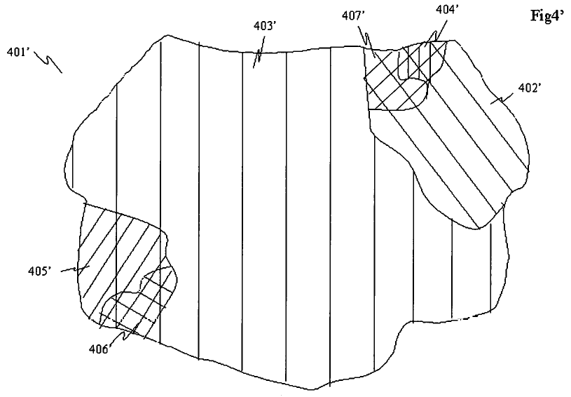

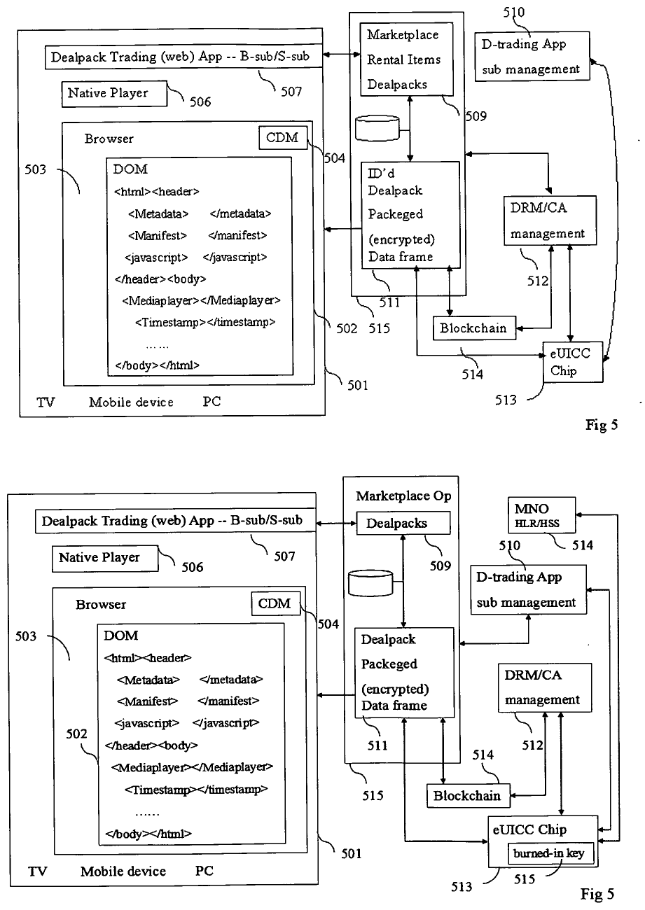

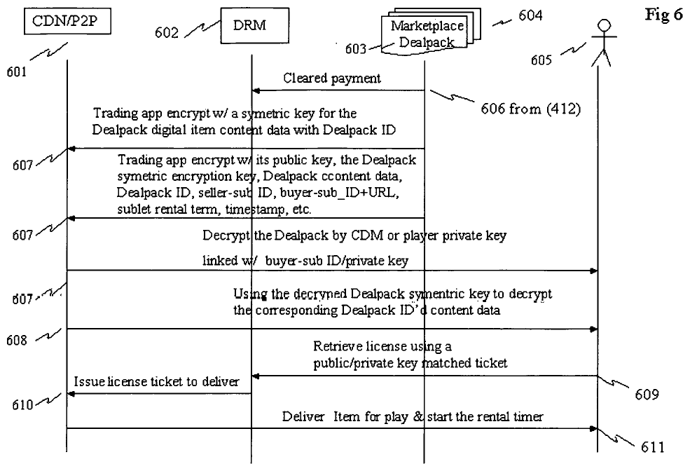

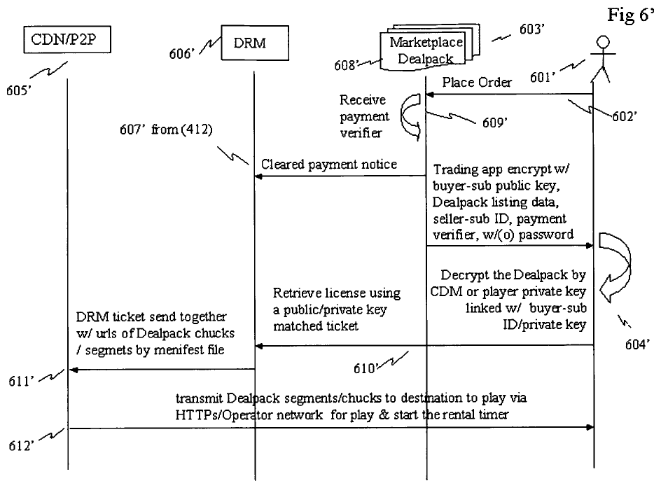

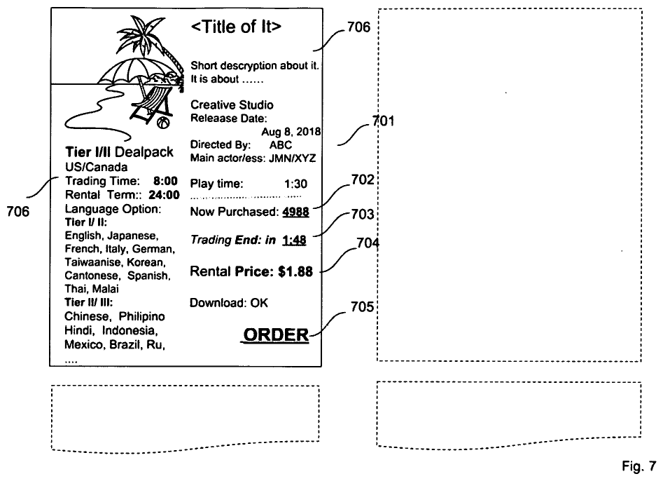

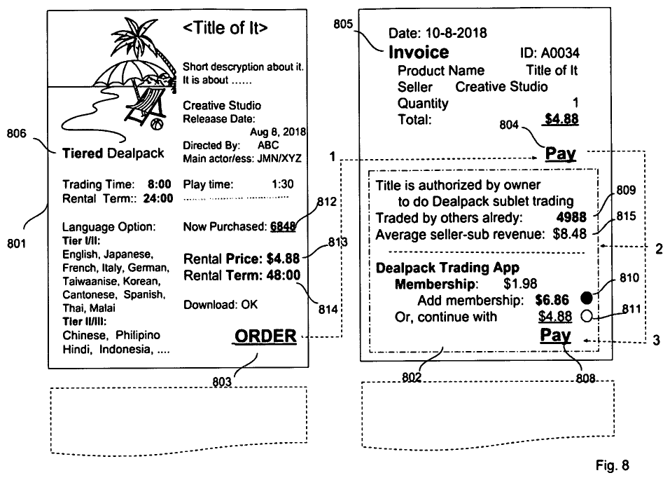

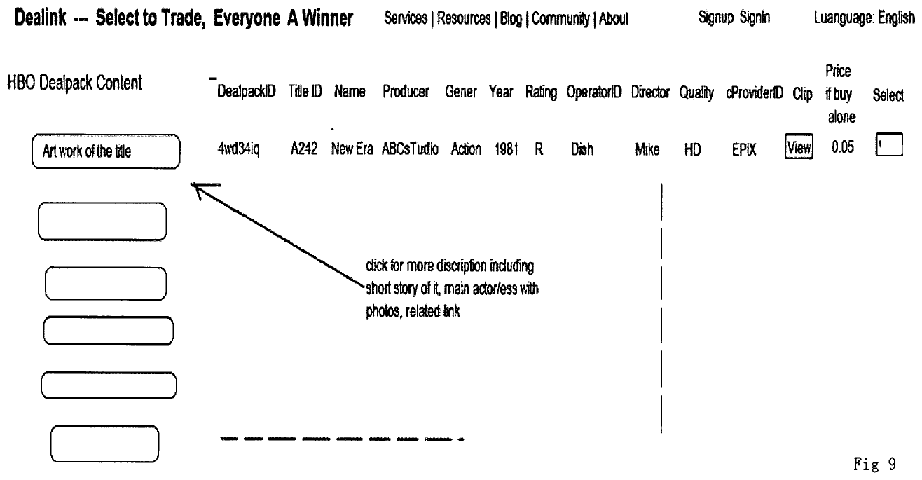

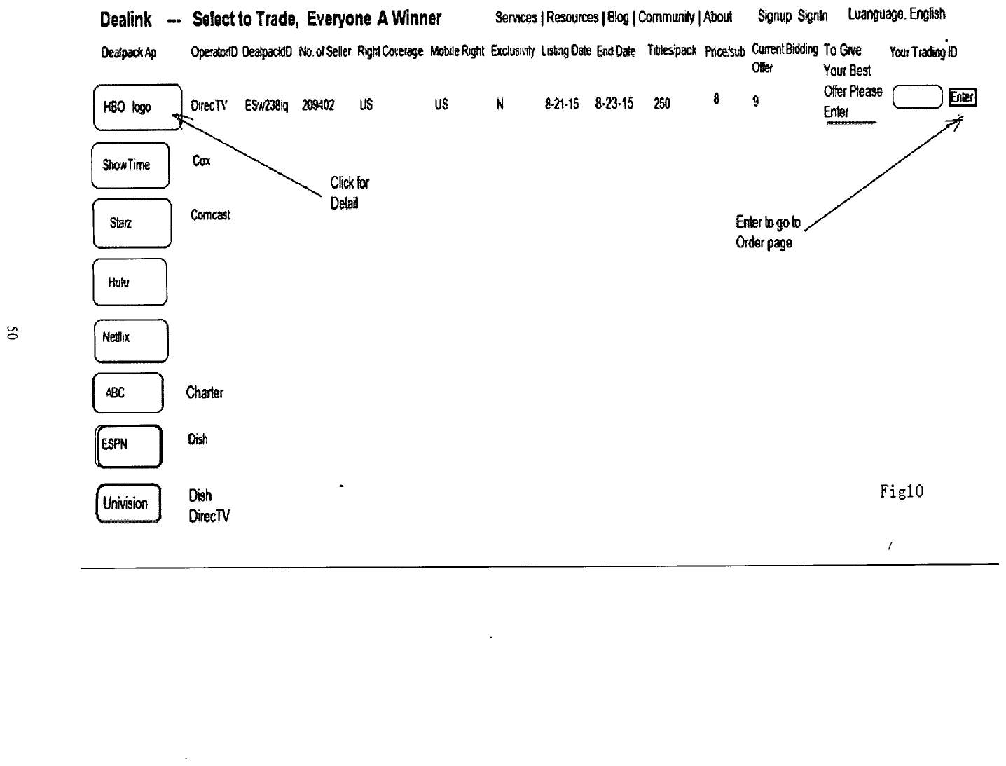

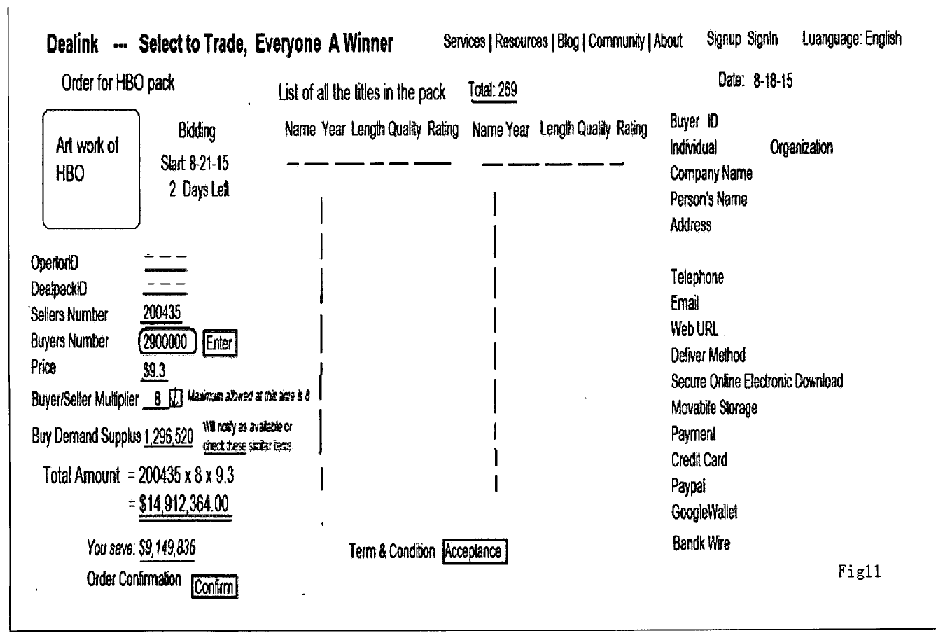

FIG. 2 described the process of current digital title transaction process of 201, and one of the exemplary transforming process 214 of regular digital title buyer 204 to a Dealpack trading app subscriber. The process start from a seller 202 selling his/her digital title 202 at the marketplace 215 by listing it for a price to sell. The buyer 204 browse the listing at the marketplace 215 and select an item 203 to buy. The order then placed 207 and the invoice is sent to buyer 208. By regular process 201, the buyer will send the payment 209 for the item 203 to seller 202 via marketplace 215, and clear payment 210, then deliver item if cleared payment 211, and item delivered 212 to buyer 204, then, file for refund if there is discrepancy 213, and enter the refund process by marketplace with seller for buyer 214. By Dealpack Trading transforming process 218, the process of step 216 shall be the same as regular step 208, where the invoice shall be sent together with an offer of Dealpack Trading app as an option to buy together with the digital item. Reason: “this item is authorized to do Dealpack sublet rental sale by its owner, revenue from the sale is possible exceeding the item paid amount, current other buyer-subs gain is averaged $xx.xx amount for your reference. But need to use the trading app to do the trade, which is $yy.yy, press <add> to add to the invoice, otherwise, complete your order by pressing the <Pay>”. If the buyer select to add the trading app, and send the payment 217, and if the payment cleared 219, the item is delivered and app is downloaded and the subscriber account is activated and ready for trade 220. If the buyer decide not to add the trading app, he/she would be just sending the payment to complete the rental purchase item 209 and the rest steps of the regular process.

The FIG. 3 is showing one of the exemplary block diagram of the Dealpack Trading app buy and sell data flow process, and FIG. 4 is the selection variable ranges/thresholds illustration. The subscribed Dealpack Trading app 301 is downloaded and installed on the device 302. For Dealpack selling, Dealpack Trading app subscriber shall use the app, for example, to browse and (1) select the ‘for-not-use’ selection C′(a′, b′, c′, d′, . . . n′) 404′ or E(a, b, c, d, . . . n) 406′, the digital title items 303 from the watched item list B(a, b, c, d, . . . n)=402′ A′(a′, b′, c′, d′, . . . n′) 402′, or, (2) right after finishing watching if pre-configured to show pop-up alert at the end of watching (unfinished watching, when stopped, can alert to finish watching, so as to have more time to trade), either option will trigger a pop-up “want to trade?—1) Trade, 2) No” alert, with choice to choose for sublet rental of the watched or just watched item C′(a′, b′, c′, d′, . . . n′) 404′ where if enter the “1) Trade” selection (could be voice prompt Q/A), will send the “For-Not-Use” (for Trade) selection C′( ) 404′, and/or E( ) 406′(selected from the overall operator digital titles content pool A′ ( ) 401′) listing item(s) of 304 digital title data object's extracted related listing data, including at least title(s)'/channel(s)' assigned Dealpack ID, manifest file, metadata with a timestamp 315 of date and time (obtained from the order placement event triggered trading app's script instruction to add a timestamp tag with a timestamp to the Dom (HTML document model) digital title's media/video object), —the starting time of the trading period Tst, to the trading portal 308 for listing the Dealpack 310 via internet secure SSL/PLS connection link 309. While in the mean time, same corresponding Dealpack ID′d video physical data 305 stored at the operator's database server 312 is also messaged 313 and marked with Dealpack ID 305 waiting for call to packaging and delivery upon order payment cleared, while for previously already sold Dealpack that are mostly traded above a control quantity Nc, shall be already packaged 307 and stored in segments/chunks of the video file for example scattered at CDNs and/or P2P networked storage 306 locations by IP addresses, encoded and encrypted, waiting for delivery call upon payment cleared. Those new Dealpack 305, upon order payment cleared, shall be encode and encrypted into packaged Dealpack 307 via SSL/TLS link 314 for example, and deliver to subscriber trading app 301 device player (native or browser build-in) via edge storage network CDNs/P2P 306 and SSL/TLS connection 311

FIGS. 4 and 3′ illustrated one of the embodiment of the Dealpack trading transaction flow process, and the digital title play-run timeline timestamp control points by Dealpack multi-tiered trading system from Tier I to III. Start from seller-sub doing sale of his Dealpack 402 by listing it on Dealpack trading marketplace 428, which upon receiving the listing data 304, shall process them by first taking an action from the Trading app 301 to instruct the script to check Ts−Tst, where the Ts is the timestamp of starting date and time of the original bought digital rental item upon purchase order paid, and the trading app shall first to determine the if the Tr meet the Tm(i) requirement, where Tm(i) is the minimum required time for a Dealpack bought to play.

### For 3 Tier Dealpack Trading,

If Tr>=4Tm(i, i=(0 to 3)),
   proceed to do 3 Tier Dealpack trading,
   otherwise, if 2Tm(2)<=Tr<=4Tm(i),
   proceed to do 1 Tier Dealpack trading,
otherwise,
   Dealpack trading is denied.
      With proceed to trading, will list the Dealpack 404, and display on the marketplace with a time ticker Ttk along the side of the Dealpack 404 sales app and/or widget and or list/mix to show the time left to buy the Dealpack 404, starting with the Tt(0), where the Ttk>=Tt(0) (controlled time period for trading), and Tt(i)<=(Tms(i)−Tst(i)); then, to process the listing data by index and/or tag and/or categorize by genre and/or mood, language and/or location, and listing the Dealpack 404 priced by selling term and rule by a function or algorithm for rental purchase, and upload 405 the selling term to the DRM 403 which linked to the player on the subscriber device 302. The buyer-sub 406 browse and select Dealpack 404 on M/S 428 to place order for rental purchase 408, The M/S 428 issue 409 invoice to buyer-sub 406 and order notice to seller-sub 402, then, the buyer-sub 406 send the payment to marketplace 428, which clear the payment 410 with seller-sub 402, and upon payment clearance confirmed 429, M/S 428 notify DRM server 412, which then issue license 413 to M/S 428 to release and deliver 414 the Dealpack 404 to buyer-sub 406 [this event will first trigger another action from the Trading app to instruct the script (such as javascript to manipulate these timestamp variables to fulfill related functions) to add another timestamp tag Tms(i), the time to start the Dealpack sublet rental term, and Tsp(i)—the time to start play the content title if Tms(i)==Tsp(i), to the Dom video object, which mark the actual starting time of the sublet rental of date and time for the Dealpack to play, (the timestamp could also be taken from the sequence timer of the the 1^{st} transmitted and received data frame header), and the business rule require Tp(i)=(Tr−Tt(i)−Tm(i)−Tm(i+1)−Tm(i+2))>=Tm(i), since Ttk's control, the Tp should be OK, thus, the purchase is honored; 2ndly, it will also trigger the Tsp(i) as a checking number to comparing with the actual consumed time's control timestamp of the playing term Tac(i) to see if the |Tac(i)−Tsp(i+1)|>Tm(i+2), where the Tm(i+2) is the time leftover to allow a Tier II trading, and also send delivery notice to buyer-sub 402 and DRM server 403 for recording the sale. If it is a rent-to-own purchasing with price P with N month of payment, it shall follow the term by doing N times monthly payments of total P×N. If sale discrepancy is happened and buyer-sub has asked for a refund 416, the sale refund procedure shall be started 417. This is the Tier-I seller-sub 402 doing sale and buyer-sub 406 doing buy process of 401. Continue will be buyer-sub 406 turned seller-sub 418 doing Tier-II sale by re-listing the bought Dealpack 404 on the marketplace 428 (or a sub-marketplace in local language) for the remaining allowable trading (Tier II if qualified) period. Same for the Tier III sublet sales that follow Tier II process, and no more Tier thereafter. Note:
i=0 to 3 Tier (i=I to III)
   Ts(i): timestamp of the starting time of the rental item purchased
   Tst(i): timestamp of the starting time of the trading period
   Tr: total time length of the original digital item's rental term
   Tt(i): time required for Dealpack trading before it is traded or bought
   Tm(i): minimum term of traded the Dealpack required time length
   Trp(i): title's full playing time length//obtained from title metadata
   Mstp(i): in-middle stop time
   Trp(i): rented title playing time full length
   Tp(i): allowable play time of sublet rental term
   Tms(i) the timestamp of the start of a trading term of a tier
   Tsp(i): the time to start play the content title
   Tac(i): control timestamp of actual consumed time of the playing term
   Ttk: marketplace a time ticker

### Refer the FIG. 3′:

$$Tr = {\sum }_{i = 0}^{3} Tmi Or , Tr = Tm 0 + Tm 1 + Tm 2 + Tm 3 , or$$

$$Tr ( total time length of the original digital item ' s rental term ) = Tm 0 ( required time length for play the rented title if Dealpack Trading wanted ) = Trp 0 ( rented title playing time full length ) + Tstp 0 ( in \text{-} middle stop time ) + Tt 0 ( time required for Dealpack trading before it is traded or bought ) + Tm 1 ( minimum term of traded the Dealpack required time length ) = Trp 1 ( title ' s full playing time length ) + Mstp 1 ( in \text{-} middle stop time ) + Tt 2 ( tier II required trading time ) + Tm 2 ( tier II minimum term length ) = Trp 2 ( title ' s full playing time length ) + Mstp 2 ( in \text{-} middle stop time ) + Tt 2 ( tier III required trading time ) + Tm 3 ( tier III minimum term length + Trp 3 ( title ' s full playing time length ) + Mstp 3 ( in \text{-} middle stop time )$$

By the exemplary case as illustrated in FIG. 3′, when a buyer-sub bought the Dealpack, the trading app shall divide the Tr into 4 equal length term for the Dealpack trading, and upon the Dealpack played by the buyer-sub, not right away but until at 301′ where the timestamp Tsp(i) of Dealpack is actually start to play inserted, the trading app shall accordingly first to decide where is the Tsp(i) located by calculating:

```
|Tsp(i)−Ts|, and comparing with |Tms(i)−Ts|,
Result: |Tms1−Ts| < |Tsp(i)−T| < |Tms3−Ts|,
  Thus to determine the Tsp(i)=Tsp2, located in Tm2
Then to see if (Tsp2−Tms2)+Tt2>=Trp2, if yes, proceed.
  Else, proceed to Tm3 w/o trading
if Tp2 (allowed play time in a Dealpack sublet rental trading term)
= Tr−Tt2−Tm0−Tm1
  >=Tm3,
  Proceed to Tt2 of Tier III trading // due to skipped Tier I+II,
  TierI=TierIII
else, Tier III trading is denied // not enough time for the Dealpack
                              to play
```

FIG. 5 and FIG. 6 illustrated one embodiment of the invention's purchased Dealpack encryption and decryption DRM/CA[control access] system's block diagram and process. When a Dealpack Trading (web) app subscriber 507 purchased a digital rental title Dealpack 509, cleared payment with seller-sub, and recorded in DRM management server/module 403, 512, 602, (in case of using blockchain: record the transaction of the Dealpack to the blockchained block with its ID, timestamp, transaction amount, and smart contract updated, which function as a DRM rental term management), where the seller-sub 402 Dealpack listing data and rental term recorded, that will lead to the marketplace operation 515 to encrypt the Dealpack content data 305, 307, together with the listing trading data 315, 310 and send to CDNs 306, 601, and if the Dealpack is a previously traded item, it will link the content data stored at the CDNs 601 by the same Dealpack ID 603 to do the encryption at once 607, 608. Note, Dealpack ID with digital title is 1-to-1 relationship, it is assigned to it when the title owner authorized the Dealpack trading right 109 and recorded/registered in a database table 110 (such as at the marketplace operation, or a blockchain operation/system 514, where the Dealpack ID asset 106 is stored in blockchain and traded by a Dealpack Trading dApp with blockchain based wallet and/or Dealpack Trading app combination). It will then deliver to buyer-sub 507 device 501, where, either using browser 503 build-in player 502, or using device native player, the buyer-sub's private key and corresponding asymmetric algorithm and matching public key together shall be used with the browser 503's decryption unit CDM 504's binding private key to decrypt 607, 608, 609,610 the encrypted Dealpack data frame 511 and play the content by the html5 player 502, or the native player's binding private key is used to decrypt the 511 to play 611. When a new buyer turned buyer-sub signed-in, and purchased rental item and do the Dealpack rental sublet sale or purchase, when the Dealpack Trading app and the marketplace system are separated business entities, the marketplace shall first authenticate the buyer-sub 507 with his/her ID through checking with the subscription management server 510 subscriber record database, and upon verification, shall allow to do next step Dealpack data encryption 607.

In the case of another embodiment of the invention where the Dealpack 203, 404, 603 content is high valued, and the content owner 104 require the “hardware-root prove of security”, it is best to use the eUICC chip 513 embedded key to do the verification and the authentication both for the buyer-sub 507 and for the Dealpack 603 content. In the case the eUICC chip embedded in a mobile device, the verification/authentication shall be done via its MNO 514, where the buyer-sub's ID is linked with the manufacture burned-in eUICC key 515 which is also linked with his/her mobile subscriber ID and together used to verify with the sub device IMSI record at MNO 514, and if device embedded secret key 515 binding device IMSI matching with the record on HLR/HSS 514, meaning the buyer-sub ID binding with the embedded key is matched too, the authentication is done, the Dealpack can be encrypted. This type verification can apply to any connected device and its carried operating application, such as the TV, PC and mobile device 501 run native player 506 and browser player 503, 502 and the Dealpack content that run through the device. Another embodiment to do this authentication, is the use a 3^{rd} party secret key management service, where the Trading App 301, 507 can use its subscriber ID key and the embedded key from the chip to do a key exchange agreement to fulled the job. Another embodiment is described in the early allowed patent Ser. No. 12/591,884.

FIG. 6′ shows the Dealpack 608 with regular value purchased after, the key flow chart. Start with buyer-sub 601′ placed the order for the Dealpack 608′, where when prompted, entering subscriber account number and password, or PIN code (manually or by voice) of the participating subscription network to confirm payment, or configured to automatically authenticate the buyer-sub by his/her device binding account number and device ID on record, and send the payment 602′, after payment cleared notice 607′ send to DRM 606′, process the payment of the buyer-sub 601 account by said trading app 603, and issuing a payment verifier 609′ upon payment made; the buyer-sub 601 then receive a payment verifier 609′ and a random number key factor generated by trading app 603, which will then encrypt buyer-sub 601's public key, Dealpack listing data, seller-sub ID, payment verifier, with/without PIN by the M/S operation 603′ and send the key package to buyer-sub603′; who will then decrypt 604′ the Dealpack 608′ by browser CDM 504 or native player 506 private key linked with buyer-sub 601′ ID/private key; the DRM 606′ then shall receive the public/private key matched ticket 610′ sent by buyer-sub 601′ for release licence ticket, together with URL/mac addresses of Dealpack 608′ chunks and/or segments by manifest file to retrieve and transmit 612″ the Dealpack data stored at the CDNs/P2P cloud to destination, the buyer-sub url/mac address to play via HTTPs and/or operator secure network for play & start the rental timer. The key flow process is administered by the trading app 603′ on behalf of the seller-sub and/or buyer-sub 601′. The buyer-sub 601′ shall accessing the Dealpack 608 for the specified time frame.

FIG. 7 illustrated the online M/S listing of the Dealpack sublet web listing app, widget, list or mix 701. It displayed the title's metadata 706, the current number ticker of the already sold 702, the time ticker showing the leftover trading time 703 based on the term and tier data, the rental sublet price 704, which is calculated by trading term and other variables determined by a price algorithm. The Tier I/II Dealpack 707 shows this is a Dealpack of Tier I or II level sublet sale and already have 4988 buyer-sub bought it, and now only 1.48 hour left to buy.

FIG. 8 described the web display of the original digital title's rental sale 801 and how the retail free buyer is transformed to a subscriber of the Dealpack Trading App. The listing block shows the current number of buyers 812 who also bought the title, the price 813, the rental term 814, and the reference of metadata about the title's Dealpack trading. When buyer press the order button 803, it will lead to step1 the invoice 805 display page or window to show the quantity and amount to confirm and pay 804, and once pressed the pay button 804, step2 pop-up box 802 will show-up and give the title Dealpack trading number 809 and status of authorization. The average other buyer-subs revenue gained amount 815 and offer join the Dealpack Trading membership by paying 808 the trading app 810 if selected, or continue with without joining the membership to pay the original invoice 805.

FIG. 9-11 illustrated an exemplary selected web pages for a Dealpack group buy and sell trading case, where the buyer company or organization will select from among listed digital channel(s) and/or title(s) by referencing related listing data FIG. 9, then drill down to next page of more detailed metadata to decide placing an order FIG. 10, upon order placed, will lead to the next detailed order data item page for confirmation FIG. 11. Still the group trading is based on group seller-subs Dealpack selling data at the moment and buyer-subs buying intent(pre-order for example) for an digital title(s) and/or channel(s) at the moment.

I claim:

1. A computer network implemented subscription trading application system and method for purchased rental digital title data item(s)'idle value sublet rental, and the purchased sublet rental item secure control access, and consumption usage and transaction tracking method and apparatus, the trading system, method, and apparatus comprise:
providing an internet online trading network marketplace, having listed digital titles and their trading app, apps of content brands, books, musics, of VOD, SVOD, AVODs, and live channels etc., free or subscribed by subscribers; said marketplace provide:
a subscription application to conducting trade by its subscribers and free users to do Dealpack Trading;
a plurality of listed items, including database servers inside company facility or network cloud outside to store and listing the digital title items, for one time buyout transaction, short term rental, Dealpack of rental and rent-to-own items, on individual retail trade basis, and/or on collective group wholesale trade basis;
a marketplace operation for processing the ordered digital title data items for secure delivery and access, including employ asymmetric and/or symmetric cryptography key methodology of encoding and decoding, and encryption and decryption of the digital title data items and Dealpack;
a digital right management operation, to record transaction and manage title license permit ticket, and trading log;
a trading app subscriber management operation for authentication, billing, service management;
a blockchain operation supported by the said subscriber management system/operation and content DRM system/operation for the digital title registration, transaction secure logging and smart contract management;
a plurality of regional marketplaces focus on regional market with localized digital title data items operation associated with the master marketplace;
having plurality of network operators connecting to the marketplaces for doing trade for their respective free users and paid subscribers;
providing support and controlled access for said free users and paid subscribers to employ devices, including front-end client side computer, mobile phone, tablet, notebook, PC, TV (analog/digital TV set) and online connecting devices, including STB[set-top-box], SMP[streaming media player], streaming dangle/sticks, game-console, and browsers or native UI of those devices, etc., to connect to the marketplace for Dealpack trading; connected with from the back-end or server side of cable/satellite head-ends, computer network nodes at the edge, or gateway-hub/container-cloud-clusters, for text, graphics, sound/voice, touch/click data input/output and data processing, storing and caching at front, and data controlled routing/relay/distribution/delivery, to and from container based cloud clusters connected via wan and/or lan (wire routed and wireless networked with access point of Wi-fi gateway/hub and/or cellular connection), and peer to peer network that are connected at the edge with terminal client devices;
a subscriber digital title data item selection process, wherein to set-up, select digital title item(s) by an array of variables to at least include time a, content b, and price c, language d from a content collection pool A(a, b, c, d, . . . n) with range/threshold property, configured to comprise step of:
put the desired to view title data item(s) selected group as B (a, b, c, d, . . . n) with range/threshold property value and assigned to respective variable(s);
put the remaining un-selected title data items as group C (a, b, c, d, . . . n) items with range/threshold property value;
determine from among C( ) group items, the group D(a, b, c, d, . . . n) that watched long time ago and don't want to watch, in reference the variables limitation, and assign values with respective variable(s); and
Determine from group B( ) and C( ) the desired to sublet item(s) as group E( ), and assign value to respective variables, and block the rest items of the A( );
assign Dealpack ID to Dealpack(A( ), D( )) and hold those item variables in memory as for-not-use, for-trade data items listening for-trade call to send out as output;
a listing process to list the Dealpack listing data to the M/S, including variables of at least title(s)'/channel(s)' and their assigned Dealpack ID, manifest file, metadata, seller-sub ID, . . . n;
a packaging process to encode and decode, encrypt and decrypt the purchased Dealpack for its protection and buyer-sub secure access;
a control accessing DRM management process in real, delayed or relayed time by selling-subscriber and buying-subscribers multiple devices via the said trading app and M/S operation, and/or a blockchain, and/or a eUICC management system for Dealpack protection and secure access of it;
a method for packaging and encrypt and decrypt the listing data and physical data of the Dealpack for secure deliver to and play for the buyer-sub;
an apparatus for secure access the Dealpack by the buyer-sub, include employ a secret key that is burned-in into a chip physical memory permanently by manufacturer, where the chip is identified as eUICC, etc., and the key is utilized by the Dealpack trading application as a root key for the said access control process;
a method to use blockchain to register Dealpack and recording its transaction and related smart contract functions, where the communication between the blockchain and/or smart contract with the trading app operation and DRM operation involving employ asymmetric and/or symmetric key operation in association with Dealpack transaction(s);
a method for controlling said Dealpack path to designated region/country and filtering its contents for rate purpose,

2. The network digital title data item selection method of claim 1, further comprise the use of a computing native menu/grid/table/tool-bar, browser Dom element and/or voice driven search, discovery, recommendation, social and trading(S/D/R/S/T) interactive UI that is display-able on television or computer operated display interface directly or via web browser interface, inter-operable for selection setup and configuration, by which once the setup configuration is done, can be used later automatically, repetitively and changeable manually any time in the middle of a session, or passively by system prompt at the end of a session according to the setup configuration; the selection process is configure to comprising:
using the TV or PC's or mobile device's native or browser carried app or widget S/D/R/S/T UI for title item(s) and/or channel(s) selection of said B( )/C( )/D( )/E( ) from A( )/C( ) to trade including at least automatic/manual confirmation for trade; also allowing subscriber to do selection by touch/click check or flag mark or by voice for a, b, c, d, . . . n variables, to determine and assign the selected value with range/threshold property to the respective variable;
selecting from B( ) item(s) in watched list and let B( )=A′( ) to then select from A′( ) the Dealpack “for-trade” item C′( ) in reference the rental term time-left ticker on the listing app or widget, if the time-left is larger than the minimum Dealpack sublet rental term, confirm the selection, assign the range/threshold value to the respective variable, together with at least seller-sub ID and send to trade; or selecting from B( ) item(s) in “watched” folder/directory/list and let B( )=A′( ), to then select from A′( ) the for-not-use=for-trade item C′( ) in reference control variables determined by operation and business variables of said trading application and have as least time interval or session variables' selection and algorithm function result(s) confirmed, assign the range/threshold value to the respective variable, together with at least seller-sub ID, and send to trade;
holding content C′( ) of Dealpack, incorporate at least time-tag and selling-subscriber ID, listening for trade call;
confirming trade or sale manually or automatically each time in the middle of a session when select so or prompted by system so at the end of a session, by pre-setup configuration to send out the Dealpack C′( ) Dealpack as output, listening the for trade call.

3. Claim 1, and 2 said selection process, further configured to comprise:
Employ plurality of 1 timestamp(s) to determine the time variable(s), including at least the timestamp of the starting time of the rental item purchased at retail M/S, timestamp of the starting time of the trading period of the Dealpack, timestamp of the start of each term of every trading tier, the timestamp of start time of the sublet rental term to play the Dealpack content title by buyer-sub, timestamp to control the actual consumed time of the playing term, and timestamp of completion of the play; also include at least timer(s) of Dealpack trading duration, the Dealpack sublet rental term, the stop time after start the title play and before its the full length finish; and respective timers' time ticker if display required; said timestamps are obtained through at least from the trading application's programming instruction of to insert respective timestamp tag into the Dom element of media/video/music player tag(s) in the case of browser, or into the native player(s) native code controlling the play; where in the timestamp of the start playing of the bought title can be obtained from the Dealpack physical package first frame upon receiving and unpacking of it; all the related time control element apply to all tiers of the Dealpack sublet rental.

4. Claim 1, 2, said selection process further configured to comprise: employ a plurality of folder/directory/list in the Dealpack Trading app, where at least include the memory area of holding the Dealpack for-trade item(s), where a trade confirmation trigger is build in to confirm trade, including at least the menu bar, button, voice activated prompt, touch/click element, and the B( ), C( ), D( ), E( ) group, and the A( )′, B( )′, C( )′ group.

5. Claim 1, 2 said selection process further configured to comprise: employ a function or algorithm to automatically pricing the Dealpack, evolve at least using variable(s) of original rental item term, Dealpack target market price index, Dealpack sublet term, seller-sub participating number.

6. Claim 1, 2 said selection process further configured to comprise: employ a table of languages of the Dealpack trading app available for the Dealpack to targeting, based on dubbed/subtitle options available, through checking check-options or pre-configured setup, to determine the value of the variable(s).

7. Claim 1 said listing data, upon trading confirmation to list the Dealpack on the M/S, shall further comprise:
associate the Dealpack ID with selection of/among-of digital content title item(s) ID, the title's owner ID, the M/S′ ID, the seller subscriber ID and the buyer subscriber/customer ID upon order placed, the seller/buyer-sub device mac address, IMSI-HLR/HSS[Int'l Mobile Subscriber Identity-Home Location Register/Home Subscriber Server], IP address, and 3^{rd} party DRM vendor ID if the vendor is hired;
Receive, index, tag, sort, classify and curate the Dealpack, insert to right position of listing, via ways of manual and/or automatic, such as artificial intelligence (AI) and machine learning (ML) algorithms, by items' metadata and resulting trained attributes, and list under the seller-sub ID and/or Dealpack ID, the title brand name, under a category/genre/mode for each item, indexed and tagged by metadata and attributes of it, with a price for rent at a term, or for rent-to-own under another business term, targeting to the business targeted market regions (if several regions involved, each region could be priced differently accordingly), control delivered by gateway routing numbers and destination buyer-sub IP address;
list by at least genre, category and/or mood for fast, easy, accurate search, discovery, recommendation, social and traded by the individual buyer renters turned seller-subs, wherein the listing display is utilizing a corresponding listing app and/or widget for the 1 to N number of digital title data item(s)' list/mix, including at least:
a plurality timestamp variables, obtained by action taken of the said trading app's instruction to programming script in response to associated event of Dealpack trading and consuming process, and added to the Dom(Document Model) elements, such as the media/video tag and timestamp tag, and used together with timer-event triggered function to control the Dealpack trading and rental duration;
assign Dealpack ID for the digital title(s) physical data stored at the M/S operation database server, waiting for packaging call;

8. Claims 1, 2, and 3 said method generated the Dealpack and its listing data from the for-not-use (for-trade) Dealpack digital title data item(s) list C′( ), using the subscription trading app, further comprising:
receiving output data of for-trade Dealpack data items from said selection process;
calling subscriber/network data from subscription service database by subscriber ID;
processing the Dealpack data items and the called data by packaging process through steps of mapping, regrouping, packaging, tagging/labeling, timing and pricing to calculate by predefined function for price;
sending the output of packaging process in the form of Dealpack label/metadata with time ticker and reference same item purchase times displayed in the frond and linked with back-end subscription/network data;
storing the Dealpack physical media data with ID and unique network address in real time networked cloud database servers/system, listening for Dealpack licensing ticket releasing call to transmit.

9. Claim 3, 4 said packaging process further comprise:
upon buyer-subscriber's order payment clearance confirmation event to processing automatically the 1 to N number of Dealpack digital title data item(s) purchased, with its/their corresponding physical media data exist in association with the listing app or widget of the title(s)′ Dealpack list/mix, together with the Dealpack ID linked the same Dealpack's listing data to encode and encrypt with the buyer-sub's public key and the Dealpack's symmetric key, seller-subscriber ID, all the listing data, and the Dealpack's symmetric key encrypted Dealpack physical data with the same Dealpack ID, and waiting for license release ticket from the said DRM server to deliver, and providing: a build-in timer started at the event of the Dealpack physical data received the licensing ticket and delivered to the buyer-sub device player by a timestamp obtained from the Dealpack trading app's instruction of the script, such as javascript to add a timestamp to the player, where if browser build-in media-player, shall be the DOM media object, with the timestamp tag, which count the starting time of the Dealpack's rental term; the timestamp could also be obtained from the first received Dealpack's physical data frame time sequence; a timer accounting the time of the time left for the rental term;

10. Claim 1, 7, 9 said DRM management system further comprise the method including:
receiving the Dealpack rental term, and related all the stakeholders ID and selling-sub service data,
recording transaction upon order fulfilled,
linking title licensing server to issue license ticket upon order payment cleared and/or receiving the decryption completion notice to activate the title data delivery;
linking with said blockchain and/or eUICC chip key management operation for exchange data to fulfill the title data delivery function;
do the above steps for the Dealpack buyer-sub turned seller-sub tier II/III Dealpack sublet sales;
settle accounts for all stakeholders of a Dealpack sublet sales

11. Claims 1, 9 and 10 said encryption and decryption of Dealpack, further comprising method:
select interested Dealpack with regular value by buyer-sub, where when prompted, entering subscriber account number and password, or PIN code (manually or by voice) of the participating subscription network to confirm payment, or configured to automatically authenticate the buyer-sub by his/her device binding account number and device ID on record;
process the payment of the buyer-sub account by said trading app, and issuing a payment verifier upon payment made;
receive a payment verifier and a random number key factor generated by trading app;
send cleared payment notice to DRM management server;
encrypt w/buyer-sub public key, Dealpack listing data, seller-sub ID, payment verifier, w/(o) PIN by the M/S operation and send to buyer-sub;
decrypt the Dealpack by browser CDM or native player private key linked with buyer-sub ID/private key;
retrieve license using a public/private key matched ticket;
send DRM ticket together with URL addresses of Dealpack chucks/segment by manifest file;
transmit Dealpack segments/chucks stored at CDNs/P2P storage to destination to play via HTTPs and/or operator secure network for play & start the rental timer
administering the issuance and submission of the Dealpack secret key by the trading app on behalf of the seller-sub and/or buyer-sub;
accessing Dealpack by buyer-sub for the specified time frame.

12. Claims 1, 9, 10 and 11 said encryption and decryption method, further comprise:
marketplace authenticate the buyer-sub through checking with the subscription management server of his/her subscriber record database, and upon verification,
The marketplace operation to encrypt the Dealpack content data, together with the listing trading data and send to CDNs and/or P2P cloud network storage, and if the Dealpack is a previously traded item, link the content title data stored at the CDNs by the same Dealpack ID to do the encryption at once.
deliver to buyer-sub device, where, either using browser build-in player, or using device native player, the buyer-sub's private key and corresponding asymmetric algorithm and matching public key together shall be used with the browser's decryption unit CDM's binding private key to decrypt the encrypted Dealpack data frame and play the content by the html5 based player', or the device native player's binding private key is used to decrypt the to play;

13. the claim 1 said eUICC chip secret key security apparatus, include:
A sim card, of physical and/or soft virtual, with build-in eUICC chip of various size cut to fit in a device, including at least mobile devices of smartphone, tablet, notebook computer, and PC, TV, STB, media-dangle/stick, IoT device, home appliance entertainment devices;
the eUICC chip is burned-in with a said trading app specified secret key with function to fulfil the “root-of-security” checking and verification through algorithms of various key matching and/or exchanging and/or chaining methodology for Dealpack and its buyer-sub identity

14. said claim 1, 10, 11, 12, 13, the secure access system for consuming the Dealpack title item further incorporate a privacy protection method, by which, the subscriber private consumption data and/or his/her identity are configured to hideout from viewed by the host operator by employ a masked identity or blockchain mechanism, which at least include a hashing method using hash functions of various type, to immune from the subscription marketplace/network host operator and the employed trading app.

15. Claim 1, 10, 14 said blockchain related matters, further comprise:
employ a sidechain of the main blockchain that operate to reduce the burden of the main-chain and be able to scale and speed up the transaction speed up to and beyond million(s) transaction per second, and together with the main blockchain, utilizing the fastest consensus method for Dealpack transaction and/or identity verification, and able to inter-op with major blockchain platform;
tokenize the Dealpack and make it smart by smart contract to facilitate its stakeholders to use as credit to pay for Dealpack trading and consumption both individuals and enterprises, keep, exchange for value appreciation and/or as equity allowing trade for other type of cryptocurrency or fiat currency to earn a profit;
equip Seller-sub and buyer-sub with Trading app and/or dApp wallets to instant transact in D-token (Dealpack token) and/or the D-token corresponding cryptocurrency of the Dealpack asset traded, where token is used for delayed currency payment by contract term;
Corresponde the tracking of the blockchain ledger as a function of a DRM to record the transaction(s), and use Dealpack ID to associate corresponding Dealpack digital title(s) physical data in CDNs and/or distributed file system for packaging and delivery;
obtain the key, asymmetric and/or symmetric, from seller-sub and/or trading app by the buyer-sub to decrypt the delivered Dealpack;
distribute the accumulated earning to respective stakeholder in accordance with the smart contract defined term by periodical fiscal duration.
